(19) United States
(12) Patent Application Publication
(10) Pub. No.: US 2018/0264318 A1
(43) Pub. Date: Sep. 20, 2018

(54) SYSTEM AND METHODS FOR A SMART WEIGHT TRAINING BELT

(71) Applicant: Blue Goji LLC, Austin, TX (US)

(72) Inventor: Coleman Fung, Spicewood, TX (US)

(21) Appl. No.: 15/992,108

(22) Filed: May 29, 2018

Related U.S. Application Data
(63) Continuation-in-part of application No. 15/853,746, filed on Dec. 23, 2017.
Application No. 15/853,746 is a continuation of application No. 15/219,115, filed on Jul. 25, 2016, now Pat. No. 9,849,333.
Application No. 15/219,115 is a continuation-in-part of application No. 15/193,112, filed on Jun. 27, 2016.
Application No. 15/193,112 is a continuation-in-part of application No. 15/187,787, filed on Jun. 21, 2016.
Application No. 15/187,787 is a continuation-in-part of application No. 15/175,043, filed on Jun. 7, 2016, now Pat. No. 9,766,696.
Application No. 15/175,043 is a continuation-in-part of application No. 15/853,746, filed on Dec. 23, 2017.
Application No. 15/853,746 is a continuation of application No. 15/219,115, filed on Jul. 25, 2016, now Pat. No. 9,849,333.
Application No. 15/219,115 is a continuation-in-part of application No. 15/193,112, filed on Jun. 27, 2016.
Application No. 15/193,112 is a continuation-in-part of application No. 15/187,787, filed on Jun. 21, 2016.
Application No. 15/187,787 is a continuation-in-part of application No. 14/846,966, filed on Sep. 7, 2015.
Application No. 14/846,966 is a continuation-in-part of application No. 14/012,879, filed on Aug. 28, 2013.
(60) Provisional application No. 62/661,220, filed on Apr. 23, 2018.
(60) Provisional application No. 62/330,642, filed on May 2, 2016.
(60) Provisional application No. 62/330,602, filed on May 2, 2016.
(60) Provisional application No. 62/310,568, filed on Mar. 18, 2016.
(60) Provisional application No. 61/696,068, filed on Aug. 31, 2012.

(51) Int. Cl. A63B 24/00; A63B 22/02; G06T 19/00; G06F 1/16; A63B 23/04; A63F 13/212; A63B 22/00; A63F 13/65; A63F 13/214; H04W 84/18

(52) U.S. Cl. CPC A63B 24/0003; A63B 22/0285; G06T 19/006; G06F 1/163; A63B 23/04; H04W 84/18; A63B 22/0046; A63B 22/0292; A63F 13/65; A63F 13/214; A63F 13/212

(57) ABSTRACT

A system and methods for a machine learning exercise belt comprising a belt, gyroscope, accelerometer, pressure sensor, electromyography (EMG) sensor and wireless adaptor, which may use machine learning algorithms and network communication to determine a weight lifter's form and intensity during exercise and provide feedback if they are performing an exercise with poor form, to help avoid injury and other consequences from poor form during weight lifting exercises.

### CROSS-REFERENCE TO RELATED APPLICATIONS

This present application is a continuation-in-part of U.S. patent application Ser. No. 15/853,746, titled “VARIABLE-RESISTANCE EXERCISE MACHINE WITH WIRELESS COMMUNICATION FOR SMART DEVICE CONTROL AND INTERACTIVE SOFTWARE APPLICATIONS”, and filed on Dec. 23, 2017, which is a continuation of U.S. patent application Ser. No. 15/219,115, titled “VARIABLE-RESISTANCE EXERCISE MACHINE WITH WIRELESS COMMUNICATION FOR SMART DEVICE CONTROL AND INTERACTIVE SOFTWARE APPLICATIONS”, and filed on Jul. 25, 2016, now issued as U.S. Pat. No. 9,849,333 on Dec. 26, 2017, which claims the benefit of, and priority to, U.S. provisional patent application Ser. No. 62/330,642, titled “VARIABLE-RESISTANCE EXERCISE MACHINE WITH WIRELESS COMMUNICATION FOR SMART DEVICE CONTROL AND INTERACTIVE SOFTWARE APPLICATIONS”, and filed on May 2, 2016, and which is also a continuation-in-part of 15/193,112, titled “NATURAL BODY INTERACTION FOR MIXED OR VIRTUAL REALITY APPLICATIONS”, and filed on Jun. 27, 2016, which claims the benefit of and priority to U.S. provisional patent application Ser. No. 62/330,602, titled “NATURAL BODY INTERACTION FOR MIXED OR VIRTUAL REALITY APPLICATIONS”, and filed on May 2, 2016, and which is also a continuation-in-part of 15/187,787, titled “MULTIPLE ELECTRONIC CONTROL AND TRACKING DEVICES FOR MIXED-REALITY INTERACTION”, and filed on Jun. 21, 2016, which is a continuation-in-part of U.S. patent application Ser. No. 15/175,043, titled “APPARATUS FOR NATURAL TORSO TRACKING AND FEEDBACK FOR ELECTRONIC INTERACTION” and filed on Jun. 7, 2016, now issued as U.S. Pat. No. 9,766,696 on Sep. 19, 2017, which claims the benefit of, and priority to, U.S. provisional patent application Ser. No. 62/310,568, titled “APPARATUS FOR NATURAL TORSO TRACKING AND FEEDBACK FOR ELECTRONIC INTERACTION” and filed on Mar. 18, 2016, the entire specification of which is incorporated herein by reference in its entirety.

This present application is a continuation-in-part of U.S. patent application Ser. No. 15/853,746, titled “VARIABLE-RESISTANCE EXERCISE MACHINE WITH WIRELESS COMMUNICATION FOR SMART DEVICE CONTROL AND INTERACTIVE SOFTWARE APPLICATIONS”, and filed on Dec. 23, 2017, which is a continuation of U.S. patent application Ser. No. 15/219,115, titled “VARIABLE-RESISTANCE EXERCISE MACHINE WITH WIRELESS COMMUNICATION FOR SMART DEVICE CONTROL AND INTERACTIVE SOFTWARE APPLICATIONS”, and filed on Jul. 25, 2016, now issued as U.S. Pat. No. 9,849,333 on Dec. 26, 2017, which claims the benefit of, and priority to, U.S. provisional patent application Ser. No. 62/330,642, titled “VARIABLE-RESISTANCE EXERCISE MACHINE WITH WIRELESS COMMUNICATION FOR SMART DEVICE CONTROL AND INTERACTIVE SOFTWARE APPLICATIONS”, and filed on May 2, 2016, and which is also a continuation-in-part of 15/193,112, titled “NATURAL BODY INTERACTION FOR MIXED OR VIRTUAL REALITY APPLICATIONS”, and filed on Jun. 27, 2016, which claims the benefit of and priority to U.S. provisional patent application Ser. No. 62/330,602, titled “NATURAL BODY INTERACTION FOR MIXED OR VIRTUAL REALITY APPLICATIONS”, and filed on May 2, 2016, and which is also a continuation-in-part of 15/187,787, titled “MULTIPLE ELECTRONIC CONTROL AND TRACKING DEVICES FOR MIXED-REALITY INTERACTION”, and filed on Jun. 21, 2016, which is a continuation-in-part of U.S. patent application Ser. No. 14/846,966, titled “MULTIPLE ELECTRONIC CONTROL DEVICES” and filed on Sep. 07, 2015, and is also a continuation-in-part of U.S. patent application Ser. No. 14/012,879, titled “Mobile and Adaptable Fitness System” and filed on Aug. 28, 2013, which claims the benefit of, and priority to, U.S. provisional patent application Ser. No. 61/696,068, titled “Mobile and Adaptable Fitness System” and filed on Aug. 31, 2012, the entire specification of each of which is incorporated herein by reference in its entirety.

### BACKGROUND OF THE INVENTION

### Field of the Art

The disclosure relates to the field of exercise equipment, specifically the field of computerized and machine-learning capable exercise equipment.

### Discussion of the State of the Art

It is currently possible for a weight trainer of any skill or dedication to go into a gym and find many types of exercise machinery, some of which may have computer chips and various levels of software on them, and some of which may be entirely mechanical in nature. Software-ready electronics are common in stationary bikes, elliptical machines, and treadmills, and in some cases exist for more specialized uses such as measuring the force exerted by a punch for boxing and other martial arts. These electronics and the software systems running on them can measure things such as estimated burned calories in a workout, the force and speed of punches or of running, the Revolutions Per Minute (RPM) of a bike and what this means for distance based on a user's settings on a stationary bike, and in some cases treadmills, elliptical machines and stationary bikes may even allow music or TV to be streamed to the user to enhance the pleasure of working out.

However, electronics with specialized software are noticeably lacking in the area of weight training, or virtually all kinds. There exists no common system which may determine the stresses an individual is undergoing while lifting in a variety of positions and warn them of, for example, poor form, uneven stresses in muscles such as if they are bench pressing, out of bounds positions such as overextending your arms during lateral pulldowns and other exercises, and more.

What is needed is a system and methods for a smart weight training belt which may aid in weight-lifting exercises for users to correct their form, load balancing, and more, and communicate with their smartphones to enable the recording of training sessions for accurate and precise measurement of exercise for competitive weight lifters.

### SUMMARY OF THE INVENTION

Accordingly, the inventor has conceived and reduced to practice, in a preferred embodiment of the invention, a system and methods for a smart weight training belt. The following non-limiting summary of the invention is provided for clarity, and should be construed consistently with embodiments described in the detailed description below.

To solve the problem of there being no wearable weight lifting apparatus which can aid in detecting exercise form, a system and methods have been devised for a machine learning exercise belt, comprising: a smart weight training belt comprising at least a processor, a memory, an accelerometer, a gyroscope, a pressure sensor, an electromyography (EMG) sensor,
a wireless network adapter, and a first plurality of programming instructions stored in the memory and operating on the processor, wherein the first plurality of programming instructions, when operating on the processor, cause the processor to: measure force caused by acceleration; gauge the orientation of the smart weight training belt; measure pressure exerted on the interior of the belt; communicate with devices over a wireless network; a smart phone device comprising at least a processor, a memory, a display screen, a wireless network adapter, and a second plurality of programming instructions stored in the memory and operating on the processor, wherein the second programming instructions, when operating on the processor, cause the processor to: communicate with devices over a wireless network; connect to the Internet; display information on a display screen; execute a weight training application; a remote server comprising at least a processor, a memory, a data store, and a third plurality of programming instructions stored in the memory and operating on the processor, wherein the third programming instructions, when operating on the processor, cause the processor to: perform read-write operations; communicate with other devices over a network including the Internet; perform operations on data; and operate machine learning algorithms using stored data.

A method for a smart weight training belt, comprising the steps of: measuring acceleration and movement of a smart weight training belt, using an accelerometer; determining orientation and movement of a smart weight training belt, using a gyroscope; measuring pressure exerted on a smart weight training belt, using one or more pressure sensors; measuring the electrical activity of a muscle, using one or more electromyography sensors; sending measured data from a smart weight training belt to a smart phone device, using a wireless network adapter; sending measured data and data on a specific desired weight training exercise to a remote server, using a smart phone device, weight training application, and remote server; comparing received data to preset values, using a data store and a remote server; performing machine learning techniques on received data, using a remote server; sending data comprising an evaluation of exercise data previously received, to a smart phone device, using a remote server, a smart phone device, and a network; and giving feedback to a user whether positive or negative feedback regarding workout performance, using a weight training application and smart phone device.

### BRIEF DESCRIPTION OF THE DRAWING FIGURES

The accompanying drawings illustrate several aspects and, together with the description, serve to explain the principles of the invention according to the aspects. It will be appreciated by one skilled in the art that the particular arrangements illustrated in the drawings are merely exemplary, and are not to be considered as limiting of the scope of the invention or the claims herein in any way.

FIG. 1 is a diagram of an exemplary hardware arrangement of a smart belt for weight lifting exercise tracking and feedback, with multiple sensors, according to a preferred aspect.

FIG. 2 is a diagram of an exemplary hardware arrangement of a smart phone device running a weight training application and communicating over a network, according to a preferred aspect.

FIG. 3 is a diagram of an exemplary hardware arrangement of key components of a server communicating over a network with a smart phone device and smart belt, according to a preferred aspect.

FIG. 4 is a method diagram of a computerized weight lifting belt communicating with a smartphone, according to a preferred aspect.

FIG. 5 is a method diagram of a weight training belt analyzing user motions and warning a user if motions for an exercise are improper, according to a preferred aspect.

FIG. 6 is a method diagram illustrating key steps in communication between a smart phone weight training application and a server communicating across a network, according to a preferred aspect.

FIG. 7 is a method diagram illustrating different motions between two common exercise routines used by weight trainers, the squat and the bench press, according to a preferred aspect.

FIG. 8 is a block diagram illustrating an exemplary hardware architecture of a computing device.

FIG. 9 is a block diagram illustrating an exemplary logical architecture for a client device.

FIG. 10 is a block diagram showing an exemplary architectural arrangement of clients, servers, and external services.

FIG. 11 is another block diagram illustrating an exemplary hardware architecture of a computing device.

### DETAILED DESCRIPTION

The inventor has conceived, and reduced to practice, a system and methods for a machine learning exercise belt.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Conceptual Architecture

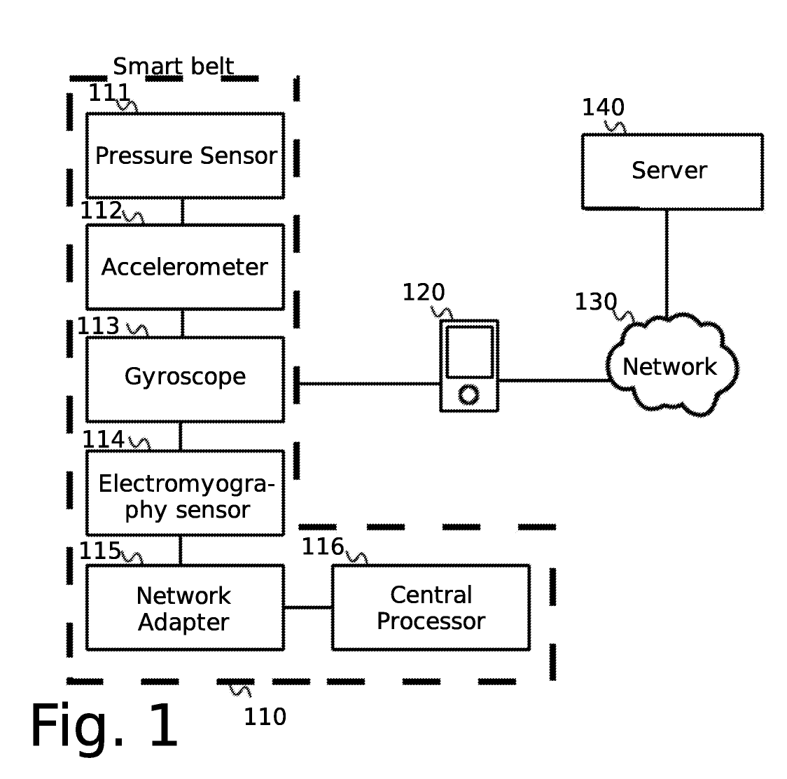

FIG. 1 is a diagram of an exemplary hardware arrangement of a smart belt 110 for weight lifting exercise tracking and feedback, with multiple sensors 111, 112, 113, 114, according to a preferred aspect. A smart belt 110 is a weight lifting belt, which is designed similarly to state-of-the-art belts designed to aid in safety and form for weight lifters, but with electronics and sensors inside for the purpose of determining exercise form and strain. Included in the belt 110 are a or more pressure sensors 111, for detecting breathing patterns in a user, as breathing patterns help indicate what form of exercise is being performed. An accelerometer 112 is also present in the belt 110, which indicates specific movements of a user wearing the belt 110, which help identify forms of exercise being performed. A gyroscope 113 is also present, which is used by the belt 110 to determine what orientation it is in, which may further aid in determining what forms of exercise are being performed. For example, a gyroscope's 113 data may be interpreted by specialized software to determine if a user is lying down, standing up, or leaning in some fashion, and combined with an accelerometer 112, software may accurately model movements and positions in space which also indicate movements and positioning of a user during exercise repetitions. Included in or wirelessly connected to the belt are one or more Electromyography (EMG) sensors 114, for detecting muscle activities and their intensities. For example, a EMG 114 data may be interpreted by specialized software to determine the muscle activities and the changing intensity and efficiency of the measured muscle. A network adapter 115 is present in the belt 110, which enables a central processor 116 to communicate over Wi-Fi, Bluetooth, or another wireless communication method which may be viable and capable of communicating with smartphone devices 120. A central processor 116 will communicate with sensory components 111, 112, 113, 114, and a network adapter 115, as well as run various software and perform other tasks as are typical for computing devices, in the use of the smart belt 110. A smartphone 120 may be used, according to a preferred aspect, to communicate with the belt 110 for the purpose of providing data to a user and communicating with a network 130 such as the Internet. A smartphone 120 may also be used to communicate with a server 140 across a network 130 for the purpose of choosing an exercise that a user is about to perform, allowing a smart belt 110 to use the sensors mentioned prior and exercise data presets on a server 140 to compare ideal data on exercise form with the form used by a user wearing a smart belt 110.

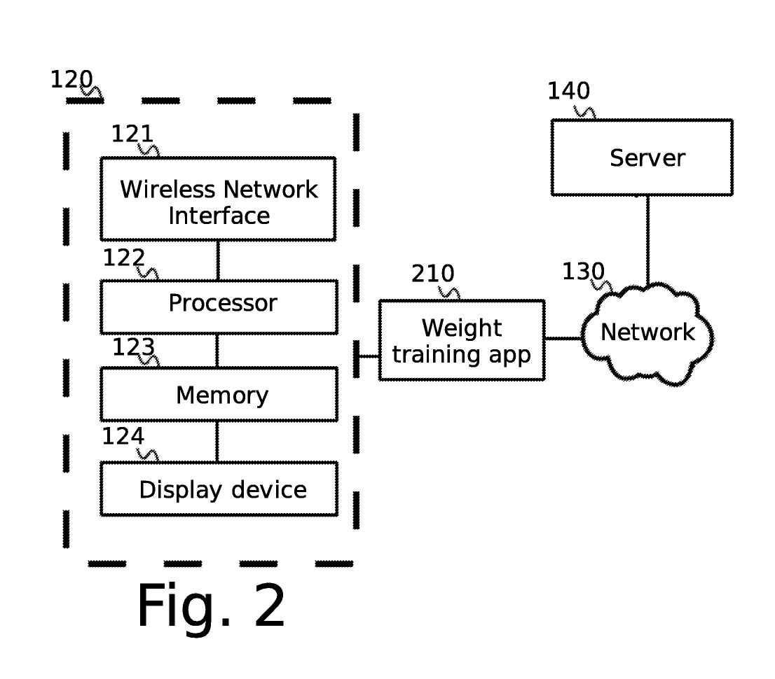

FIG. 2 is a diagram of an exemplary hardware arrangement of a smart phone device 120 running a weight training application 210 and communicating over a network 130, according to a preferred aspect. In an exemplary smart phone device 120, key components include a wireless network interface 121, which may allow connection to one or a variety of wireless networks including Wi-Fi and Bluetooth; a processor 122, which is capable of communicating with other physical hardware components in the cellular device 120 and running instructions and software as needed; system memory 123, which stores temporary instructions or data in volatile physical memory for recall by the system processor 122 during software execution; and a display device 124, such as a Liquid Crystal Display (LCD) screen or similar, with which a user may visually comprehend what the cellular device 120 is doing and how to interact with it. It may or may not be a touch enabled display, and there may be more components in a cellular device 120, beyond what are crucially necessary to operate such a device at all. Software operating on a processor 123 may include a weight training application 210, whose primary function is to communicate over a network 130 with other devices such as a computer server 140.

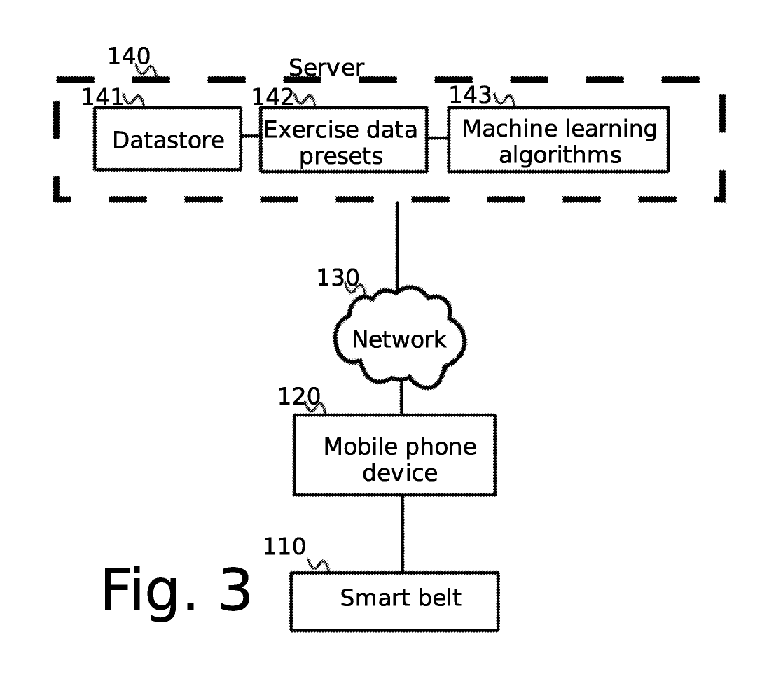

FIG. 3 is a diagram of an exemplary hardware arrangement of key components of a server 140 communicating over a network 130 with a smart phone device 120 and smart belt 110, according to a preferred aspect. An exemplary computer server 140 must have at the very least, a database or similar data store configuration 141, which may be configured for Structured Query Language (SQL) or in a NoSQL format including MongoDB as desired upon implementation. Stored in a data store 141 are preset accelerometer 112, gyroscopic 113, pressure-sensed 111, and EMG 115[?]data values, keyed to specific exercise routines 142. For example, with this data as interpreted in a weight-belt paradigm, one may represent the orientation, movements, time durations, breathing patterns, and electrical activities of various muscle groups of a user as they exercise, which serve to indicate form, intensity, stress, and efficiency of workouts. Operating on a computer server 140 are machine learning algorithms such as reinforcement learning techniques 143, which serve to update these preset values 142 for expected exercise movements from users, according to server configuration which may be defined upon implementation, according to a preferred aspect. For example, an operator of one such server may use these algorithms 143 and a smart belt 110 device communicating with a computer server 140 to adjust preset values 142 according to measurements taken with a smart belt device 110 during exercise. A computer server 140 may communicate over a network 130 with a smart phone device 120, which in turn is connected with a wireless network interface 121 to a smart belt 110 device, thereby allowing a chain of communication from a smart belt 110, to a computer server 140 which may store data on belt usage and report whether or not data sent by a belt 110 indicates correct or improper exercise form.

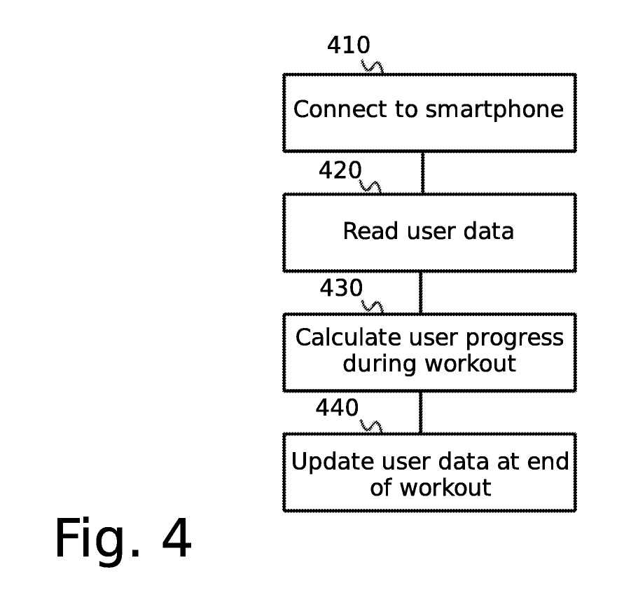

FIG. 4 is a method diagram of a computerized weight lifting belt communicating with a smartphone, according to a preferred aspect. A smart belt 110 may connect to a smartphone 120, 410, using a network adapter 115 which may be used to communicate across either Wi-Fi or Bluetooth communications protocols, or other communications protocols and standards that may be useful and common for local inter-device communication. A connected smartphone 120 and belt 110 may then transfer data, specifically a smart belt 110 may read data from a smartphone 120, 420 for the purposes of determining what workout a user has chosen to perform. A smart belt 110 may then determine a user's workout progress 430, which may be used for a user to keep track of their routines, which is very important to most weight lifters and athletes. After any needed calculations and operations are made, a smart belt 110 may upload changes to a user's workout profile 440 to a smartphone 120, to later be reviewed if necessary, or to upload to further websites such as social media websites and workout training websites.

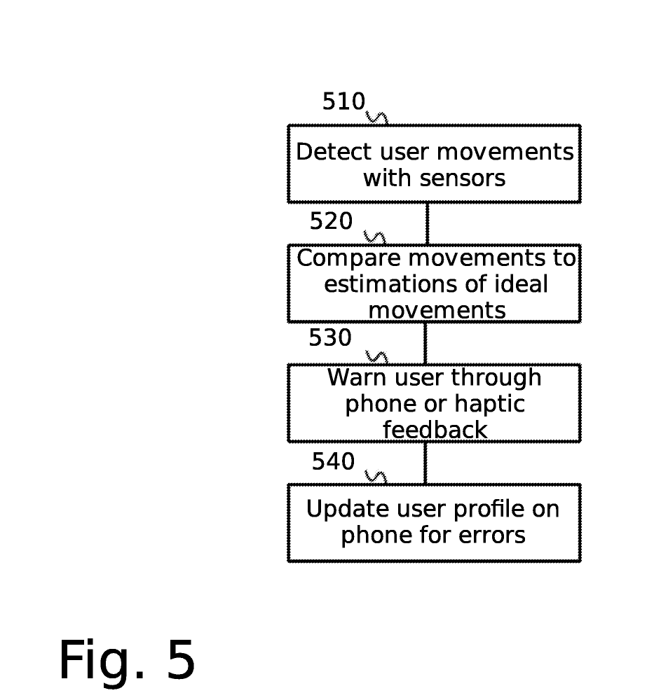

FIG. 5 is a method diagram of a weight training belt analyzing user motions and warning a user if motions for an exercise are improper, according to a preferred aspect. First, using a suite of sensors 111, 112, 113 present in a smart belt 110, a smart belt 110 may detect user motions and muscle activities 510, combining the use of a pressure sensor 111, accelerometer 112, gyroscope 113, and EMG sensors to determine position, orientation, movement, breathing patterns and intensity level of a user. When a smart belt 110 collects this information 510, it may then compare the estimation of user behavior with estimations of proper exercise form for a given selected exercise routine 520 selected on their smartphone 120. Machine learning techniques such as reinforcement learning may be used to produce the initial values for proper exercise form for a variety of popular weight lifting techniques, according to a preferred aspect. If a user is determined by a smart belt 110 to be using incorrect form on an exercise for some reason such as improper body positioning or a breathing pattern which may be disadvantageous or prone to injury, feedback can be provided to a user's smartphone 116 which may either be a noise from the device, phone's vocal or a form of haptic feedback such as vibration 530 as is common with such devices. After a workout is completed, if there were errors during any repetition of exercises, such data may be recorded on a user's smartphone 116 such that a user may review their deficiencies according to recorded data 540 as measured by a smart belt 110.

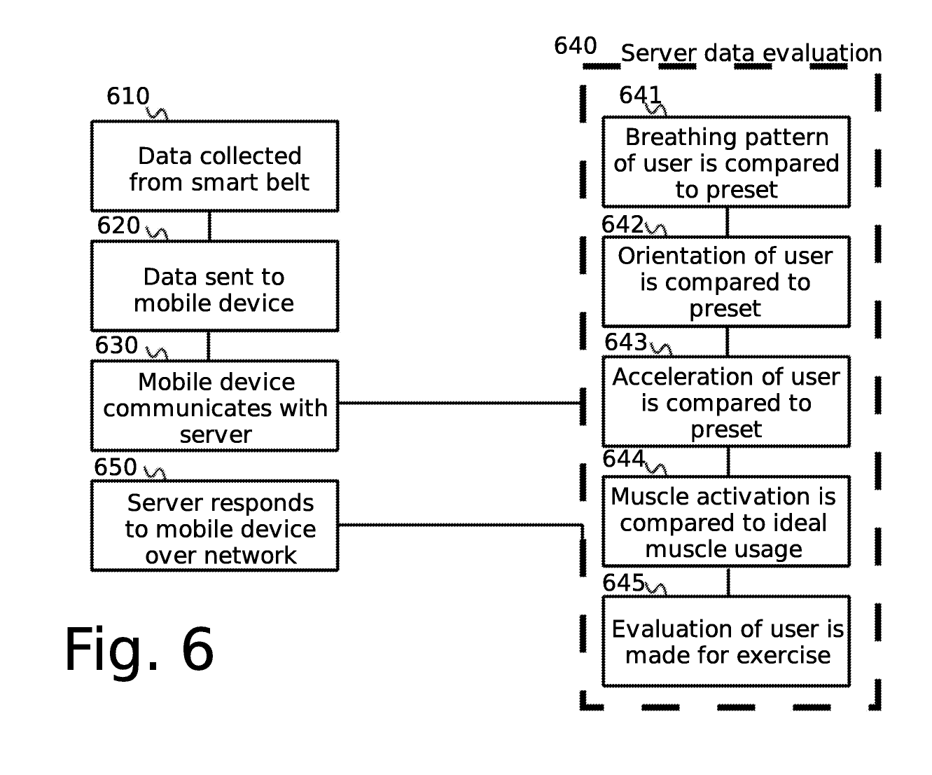

FIG. 6 is a method diagram illustrating key steps in communication between a smart phone 120 weight training application 210 and a server 140 communicating across a network 130, according to a preferred aspect. First, data must be collected from a smart belt device 110, 610, which may be communicated to a smart phone device 120, 620 using network adapters in both devices 115, 121. Data collected is data from the sensor suite in a smart belt 110, comprising a pressure sensor 111, accelerometer 112, gyroscope 113, and EMG sensors 114. After data gathered by a smart belt 610 is communicated to a smart phone device 620, said smart phone device may communicate over a network 130 to a computer server 140, 630, where a computer server may run a series of operations after receiving data 640. Data operations include comparing measured breathing pattern data to preset data for whatever exercise a user may be performing 641, in which case more erratic breathing than is recommended by a computer server 140 may be cause for concern. For example, hyperventilating during intense physical weight training may cause a user to lose consciousness, which can result in severe injury or death. Similarly, holding breath too long increases tension in the body and can result in numerous injuries including hernia and increased blood pressure. In addition to checking breathing patterns against preset values 641, a computer server 140 may compare orientation of the user to orientation data stored as a preset value in a database 141, 642. Orientation data may be used in situations such as squat exercising, where the orientation of a person during the exercise may cause severe injury if performed incorrectly. For example, if a user leans too far forward during a squat, they may lose control of their balance and fall forward, which may be extremely dangerous when using weights for exercise. Orientation during a full repetition of an exercise indicates body posture which is crucial to safe and effective weight training. In addition to comparing breathing patterns 641 and orientation 642 of a user to a preset optimal value in a data store 141, the acceleration of a smart belt is measured and compared to preset values 643, such that in the case of exercises such as a deadlift, a user's speed may be measured as they life up a barbell from resting position. If a user moves too quickly in such an exercise, they may put too much stress on joints and cause injuries. In addition to these methods of measuring user activity, EMG sensors 114 are used to measure muscle activation and intensity of the user 644 and compared to an optimal value in a data store 141. In this way the system may determine which muscles are being used the most during exercise, which is important for safety during exercise. For example, if muscles are used improperly during an exercise, such as twisting your body during a squat, it is possible to fall or damage your muscle tissue, severely injuring a weight lifter or even killing them in extreme circumstances. After these comparisons may be made, a total evaluation of all errors detected in exercise form and execution may be made 645, which may then be sent in a response back to a smart phone device 650, to warn a user through phone feedback 530, either audio or some other form of feedback as the smart phone 120 may be capable of.

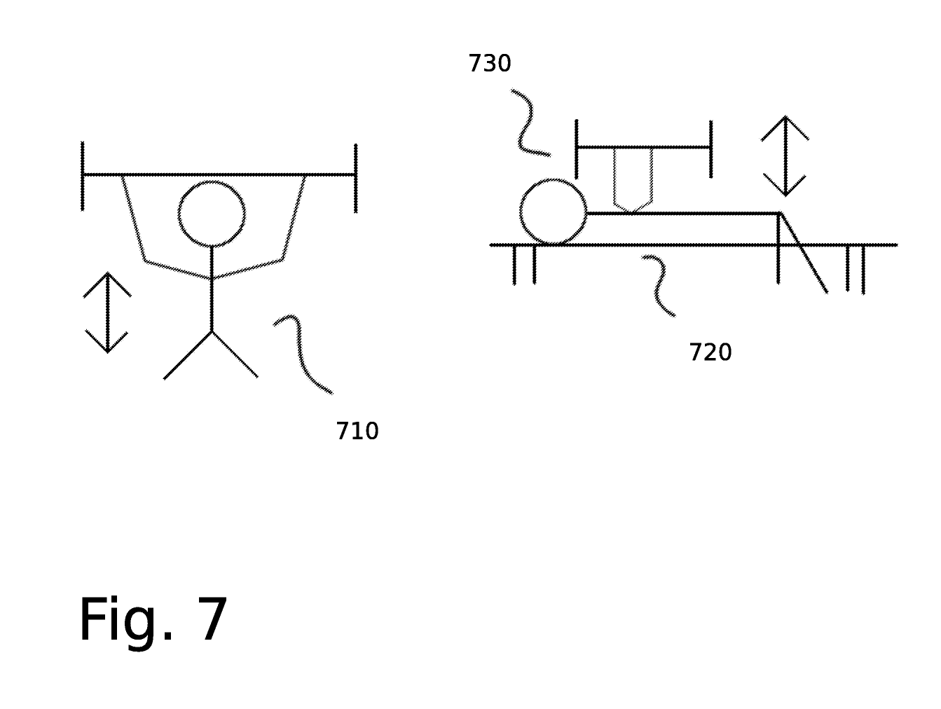

FIG. 7 is a diagram illustrating different motions between two common exercise routines used by weight trainers, the squat 710 and the bench press 730, according to a preferred aspect. In this diagram there are two common exercises shown, a squat 710, which in many cases involves a user holding a barbell with or without weights on their shoulders, and performing a squatting maneuver up and down, with specific form regarding knee and hip movements and feet placement. Another common exercise shown is a bench press 730, performed on a weightlifting bench f, where a user lies down on a bench 720 and lifts a barbell with or without weights added, up and down from near their chest, into the air. Errors which may be detected in these common exercises include improper orientation such as leaning forward or backward during a squat, or sitting up during a bench press, using a gyroscope 113; performing the exercise too quickly as in the case of the squat, or performing it haphazardly in motion, as detected by an accelerometer 112; or bad breathing practices, which may be detected by a pressure sensor 111 and is relevant to all weight lifting techniques, including the bench press 730 and squat 710. Exercises which have different forms, such as those shown, may have different preset values in a data store 141, which changes the evaluation of a user's performance 645. A bench press may be evaluated differently than a squat for example, as described above in the differences between their form and execution.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (“ASIC”), or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines, or other appropriate virtual environments).

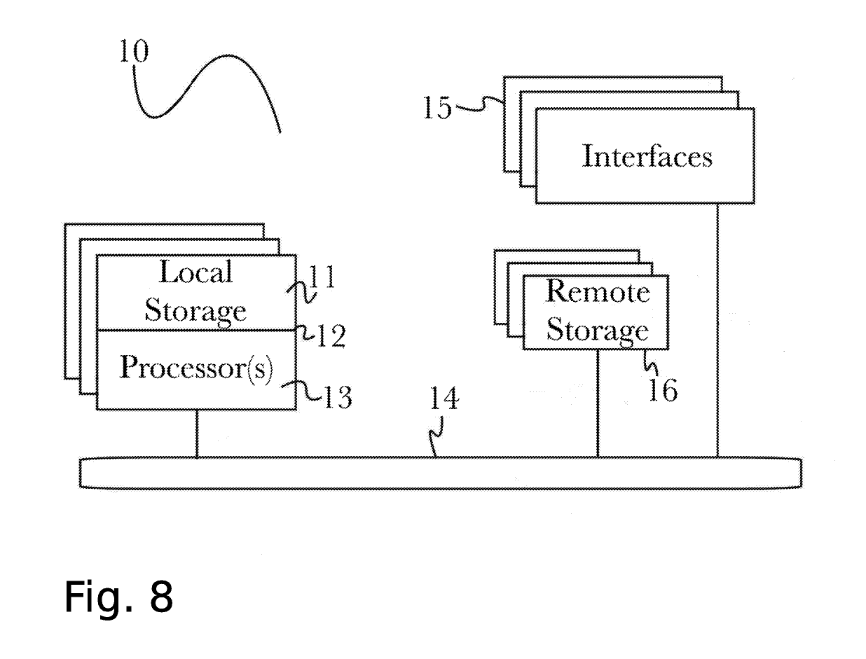

Referring now to FIG. 8, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one embodiment, a computing device 10 may be configured or designed to function as a server system utilizing CPU 12, local memory 11 and/or remote memory 16, and interface(s) 15. In at least one embodiment, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a specific embodiment, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 8 illustrates one specific architecture for a computing device 10 for implementing one or more of the inventions described herein, it is by no means the only device architecture on which at least a portion of the features and techniques described herein may be implemented. For example, architectures having one or any number of processors 13 may be used, and such processors 13 may be present in a single device or distributed among any number of devices. In one embodiment, a single processor 13 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

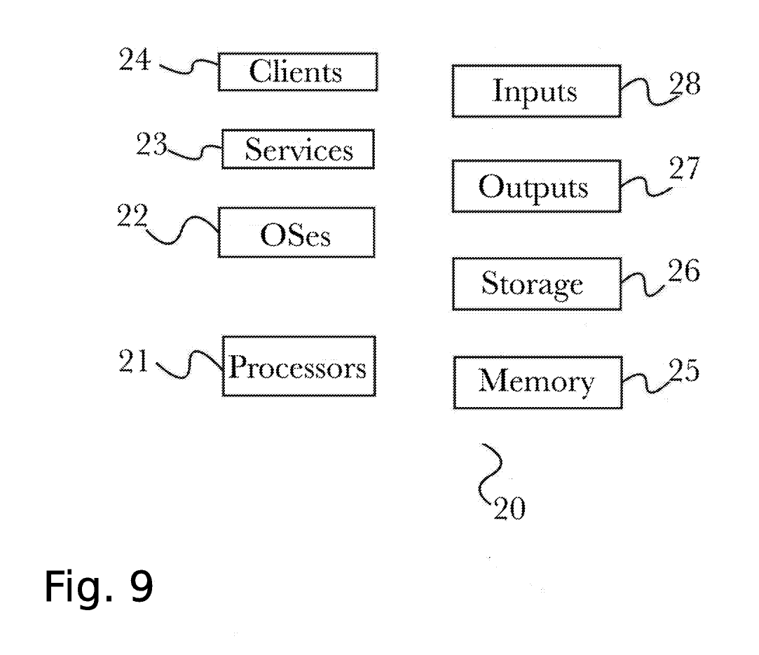

In some embodiments, systems according to the present invention may be implemented on a standalone computing system. Referring now to FIG. 9, there is shown a block diagram depicting a typical exemplary architecture of one or more embodiments or components thereof on a standalone computing system. Computing device 20 includes processors 21 that may run software that carry out one or more functions or applications of embodiments of the invention, such as for example a client application 24. Processors 21 may carry out computing instructions under control of an operating system 22 such as, for example, a version of MICROSOFT WINDOWS™ operating system, APPLE OSX™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 8). Examples of storage devices 26 include flash memory, magnetic hard drive, CD-ROM, and/or the like.

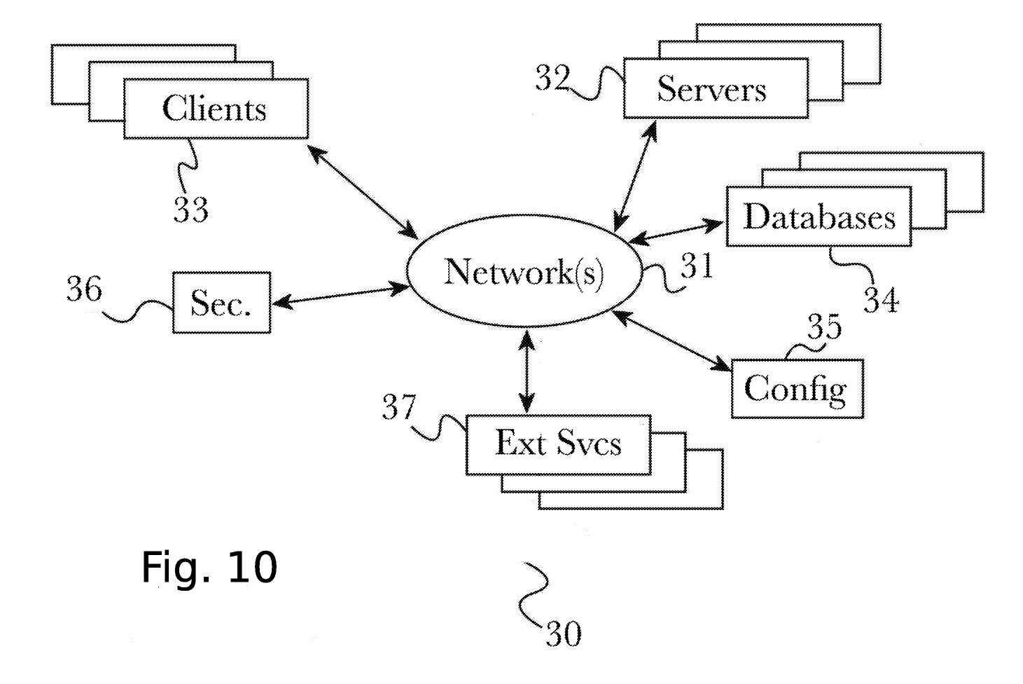

In some embodiments, systems of the present invention may be implemented on a distributed computing network, such as one having any number of clients and/or servers. Referring now to FIG. 10, there is shown a block diagram depicting an exemplary architecture 30 for implementing at least a portion of a system according to an embodiment of the invention on a distributed computing network. According to the embodiment, any number of clients 33 may be provided. Each client 33 may run software for implementing client-side portions of the present invention; clients may comprise a system 20 such as that illustrated in FIG. 9. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the invention does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in an embodiment where client applications 24 are implemented on a smartphone or other electronic device, client applications 24 may obtain information stored in a server system 32 in the cloud or on an external service 37 deployed on one or more of a particular enterprise's or user's premises.

In some embodiments of the invention, clients 33 or servers 32 (or both) may make use of one or more specialized services or appliances that may be deployed locally or remotely across one or more networks 31. For example, one or more databases 34 may be used or referred to by one or more embodiments of the invention. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 36 or configuration system 35 or approach is specifically required by the description of any specific embodiment.

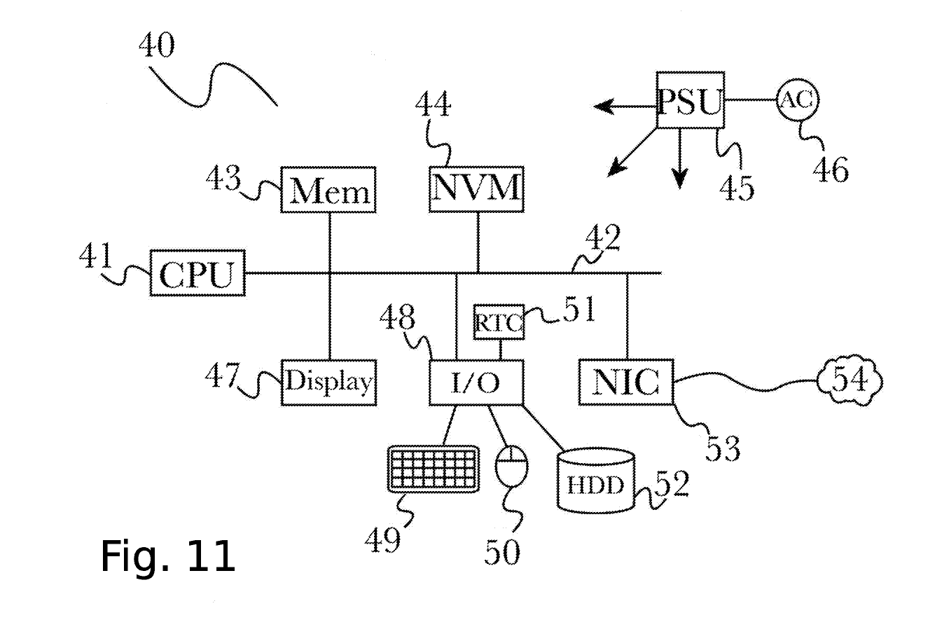

FIG. 11 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

The skilled person will be aware of a range of possible modifications of the various embodiments described above. Accordingly, the present invention is defined by the claims and their equivalents.

What is claimed is:

1. A system for a machine learning exercise belt, comprising:
a smart weight training belt comprising at least a processor, a memory, an accelerometer, a gyroscope, a pressure sensor, an electromyography sensor, a wireless network adapter, and a first plurality of programming instructions stored in the memory and operating on the processor, wherein the first plurality of programming instructions, when operating on the processor, cause the processor to:
measure force caused by acceleration;
gauge the orientation of the smart weight training belt;
measure pressure exerted on the interior of the belt;
measure the electrical activity of a given muscle;
communicate with devices over a wireless network;
a smart phone device comprising at least a processor, a memory, a display screen, a wireless network adapter, and a second plurality of programming instructions stored in the memory and operating on the processor, wherein the second programming instructions, when operating on the processor, cause the processor to:
communicate with devices over a wireless network;
connect to the Internet;
display information on a display screen;
execute a weight training application;
a remote server comprising at least a processor, a memory, a data store, and a third plurality of programming instructions stored in the memory and operating on the processor, wherein the third programming instructions, when operating on the processor, cause the processor to:
perform read-write operations;
communicate with other devices over a network including the Internet;
perform operations on data; and
operate machine learning algorithms using stored data.

2. The system of claim 1, wherein the smart belt is worn in only one orientation on a user.

3. The system of claim 1, wherein a pressure sensor is used to measure breathing patterns of a user during exercise.

4. The system of claim 1, wherein the pressure sensor is used to measure muscle exertion on the belt, during exercise performed by a user.

5. The system of claim 1, wherein the belt communicates with a smartphone device via an embedded wireless network adapter.

6. The system of claim 1, wherein a remote server is stored on-site at a gym.

7. The system of claim 1, wherein a remote server is stored off-site at a separate facility from a gym.

8. The system of claim 1, wherein machine learning may be used by an administrator to alter preset values held in a data store, using a remote server.

9. A method for a machine learning exercise belt, comprising the steps of:
measuring acceleration of a smart weight training belt, using an accelerometer;
determining orientation of a smart weight training belt, using a gyroscope;
measuring pressure exerted on the interior of a smart weight training belt, using a pressure sensor;
measuring electrical activity on a given muscle, using an EMG sensor;
sending measured data from a smart weight training belt to a smart phone device, using a wireless network adapter;
sending measured data and data on a specific desired weight training exercise to a remote server, using a smart phone device, weight training application, and remote server;
comparing received data to preset values, using a data store and a remote server;
performing machine learning techniques on received data, using a remote server;
sending data comprising an evaluation of exercise data previously received, to a smart phone device, using a remote server, a smart phone device, and a network; and
giving feedback to a user whether positive or negative feedback regarding workout performance, using a weight training application and smart phone device.

10. The method of claim 9, wherein the smart belt is worn in only one orientation on a user.

11. The method of claim 9, wherein the pressure sensor is used to measure breathing patterns of a user during exercise.

12. The method of claim 9, wherein the pressure sensor is used to measure muscle exertion on the belt, during exercise performed by a user.

13. The method of claim 9, wherein the belt communicates with a smartphone device via an embedded wireless network adapter.

14. The method of claim 9, wherein a remote server is stored on-site at a gym.

15. The method of claim 9, wherein a remote server is stored off-site at a separate facility from a gym.

16. The method of claim 9, wherein machine learning may be used by an administrator to alter preset values held in a data store, using a remote server.
